(19) United States
(12) Patent Application Publication
(10) Pub. No.: US 2024/0150565 A1
(43) Pub. Date: May 9, 2024

(54) POLYAMIDE COMPOSITION WITH INCREASED HYDROLYSIS RESISTANCE, A PROCESS FOR PREPARING THE SAME, ITS APPLICATION AND AN ARTICLE MADE THEREFROM

(71) Applicant: BASF SE, Ludwigshafen (DE)

(72) Inventors: Huan Bing WANG, Shanghai (CN); Lu Ping ZHAO, Shanghai (CN); Ying TAO, Shanghai (CN); Guang Rui TANG, Shanghai (CN)

(21) Appl. No.: 18/550,233

(22) PCT Filed: Mar. 14, 2022
(86) PCT No.: PCT/EP22/56470

§ 371 Date: Sep. 12, 2023

(30) Foreign Application Priority Data
Mar. 23, 2021 (WO) PCT/CN21/82406

(51) Int. Cl. C08L 23/12

(52) U.S. Cl. CPC C08L 23/12; C08L 2203/18; C08L 2205/08

(57) ABSTRACT

Disclosed herein is a polyamide composition with improved hydrolytic resistance, which includes (a) 10 wt % to 40 wt % of polyamide 6, (b) more than 35 wt % to 50 wt % of poly-propylene, (c) 0.5 wt % to 10 wt % of a compatibilizer, and (d) 25 wt % to 50 wt % of reinforcing fillers, based on the total weight of the polyamide composition. The disclosed polyamide composition is suitable to prepare an article for cooling circuits in automobiles.

### TECHNICAL FIELD

The present invention relates to a polyamide composition with increased hydrolysis resistance, especially suitable for preparing an article used in the cooling circuits of automobiles. The invention also relates to a process for preparing the composition, its application and an article made from the composition.

### BACKGROUND ART

In the automobile field, coolant used in the cooling circuit usually comprises a mixture of ethylene glycol and water, preferably in a ratio of 1:1. In addition to this, small amounts of stabilizers are also used, especially in what are known as “longlife coolants” (LLC for short).

Polyamide (PA) has been attempted to produce components for the cooling circuits of automobiles. The resistance of polyamide composition to the coolant, such as mixtures of water and ethylene glycol is known as hydrolysis/glycolysis resistance and is often determined by using standard test specimens which are stored in the water/ethylene glycol mixture at from 120 to 135° C. in pressure-tight steel containers for 7, 21 and 42 days. After the storage procedure, mechanical tests are undertaken on the standard test specimens, preferably tensile tests, flexural tests, or impact-resistance determination, and the resultant properties are compared with those of standard test specimens freshly injection-molded and not stored in the water/ethylene glycol mixture. Common test methods to characterize the mechanical properties of polymers are described in, for example, the international standards ISO527, ISO178, ISO179 and ISO180.

It is known from EP 2562220 A1 that the polyamide mixed with copolymers of olefin and acrylate, and further containing a stabilizer, has sufficient hydrolytic stability to be applied in the cooling circuit of an automobile. Also, compounded materials made of glass-fibre-reinforced PA 6,6 (of nylon-6,6) have become established in automobile construction for producing components for the cooling circuits of automobiles because of its good resistance to coolant. It is noted that PA 6,6 begins to dissolve in ethylene glycol at 160° C., even conventional 1:1 mixtures of ethylene glycol and water attack glass-fibre-reinforced polyamides as soon as temperatures are above 100° C.

The process known as hydrolysis/glycolysis is comparatively slow at low temperatures, but is accelerated by higher temperatures.

For PA 6,6 and partially arylated polyamides, WO2017189761A1, DE4214193A1, EP2933285A1, U.S. Pat. No. 5,360,888A, and US20070066727A1 teach to apply monomers, oligomeric or polymeric carbodiimides etc. as a specific stabilizer to improve its hydrolytic stability. However, compared with other common polymers, the disadvantage of using PA 6,6 and partially arylated polyamides is that they are relatively expensive.

PA 6, which is cheaper than PA 6,6, showed inferior performance in coolant resistance and even if a few amount of PA 6 is introduced into PA 6,6, the coolant resistance properties would drop dramatically and PA 6 is thus considered as not suitable for cooling circuit application in automobile industry.

The present invention aims to provide a polyamide composition which is suitable for preparing an article for a cooling circuit in an automobile, meets the requirements of hydrolytic stability of an article for a cooling circuit in an automobile and overcomes the disadvantages of the prior art especially from an economic point of view.

### SUMMARY OF INVENTION

The inventors of the present invention have made attempts to solve the above problems and surprisingly found that a composition based on polyamide 6 (PA 6) and additionally comprising polypropylene (PP for short) and a compatibilizer, can meet the requirements of the automotive industry in terms of hydrolytic stability. Despite of the prejudice that the composition of PA6 is generally considered as not suitable for cooling circuit application in automobile industry, the present inventor has made significant progress on making the composition based on PA6 fit for such application and dramatically lower the cost in such application.

It is for the first time that the inventors have found PA 6 when blended with a certain amount of PP and a compatibilizer, can prepare an article with improved hydrolytic resistance and thus suitable for a cooling circuit in an automobile.

In one aspect of the present invention, it is provided a polyamide composition, which comprises: (a) 10 wt % to 40 wt % of polyamide 6 (PA 6), (b) more than 35 wt % to 50 wt % of polypropylene (PP), (c) 0.5 wt % to 10 wt % of a compatibilizer, and (d) 25 wt % to 50 wt % of reinforcing fillers, based on the total weight of the polyamide composition.

Further, the present invention provides a manufacturing process of the polyamide composition, comprising injection molding, extruding or blow molding all components of the polyamide composition.

Still further, the present invention provides use of the polyamide composition in preparing an article contacting a cooling medium, especially in the cooling circuit of an automobile.

Still further, the present invention provides an article prepared from the above-mentioned polyamide composition.

According to the present invention, the article prepared from the above polyamide composition has achieved improved hydrolytic resistance.

### DETAILED DESCRIPTION OF EMBODIMENTS

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” refers to a range of numbers that a person of skill in the art would consider equivalent to the recited value in the context of achieving the same function or result.

As used herein, the term “comprising one” should be understood as being synonymous with the term “comprising at least one”, and “between” should be understood as being inclusive of the limits.

Unless otherwise identified, all percentages (%) are “percent by weight”.

### (a) Polyamide 6

There is no specific limit to PA 6 and PA 6 produced by many known types of process in the field can be used as component (a) in the polyamide composition according to the invention. The industrially relevant processes for producing the PA 6 include such as condensation in the melt, the hydrolytic polymerization of caprolactam and so on.

PA 6 in the polyamide composition is in the amount of 10 wt % to 40 wt %, preferably of 15 wt % to 35 wt % or more preferably 15 wt % to 30 wt %, based on the total weight of the polyamide composition.

The viscosity number of the PA 6 to be used as component (a) is preferably from 95 to 230 ml/g, particularly preferably from 110 to 170 ml/g, wherein the relative viscosity can be determined or measured in sulfuric acid solution of 96 wt % at 25° C. according to ISO307-2007.

The polyamide 6 in the present invention could be the homopolymer of polyamide 6 and could also be the copolymer of polyamide 6 and other crystalline polyamides, the total molar mass of other polyamides in the copolymer is less than 50 mol %, preferably less than 20 mol %, more preferably less than 10 mol %. The other crystalline polyamides could be aliphatic polyamide, semi-aromatic polyamide and the mixture thereof. Examples of other crystalline polyamide could be polyamide 6,6, polyamide 4,6, polyamide 11, polyamide 12, polyamide 6,10, polyamide 6,12, polyamide 6T, polyamide 9T, polyamide 6T/61 (terephthalic acid:isophthalic acid=6:4-8:2).

The polyamide 6 in the present invention could be the blends of polyamide 6 and other polyamides. The amount of other polyamide in the polyamide composition is in the amount of from 0 to 20 wt %, preferably from 0 to 10 wt %, based on the total weight of the polyamide composition. The other polyamides could be aliphatic polyamide, semi-aromatic polyamide and the mixture thereof. Examples of other polyamide could be polyamide 6,6, polyamide 4,6, polyamide 11, polyamide 12, polyamide 6,10, polyamide 6,12, polyamide 6T, polyamide 9T, polyamide 6T/61 (terephthalic acid:isophthalic acid=6:4-8:2).

### (b) Polpropylene

It has been surprisingly found that when more than 35 wt % to 50 wt % of PP, together with a compatibilizer is added into the composition comprising PA 6, the hydrolytic resistance of the article prepared from the polyamide composition of the present invention can be improved.

The amount of the PP in the polyamide composition is more than 35 wt % to 50 wt %, preferably 36 wt % to 45 wt %, more preferably 36 wt % to 41 wt %, based on the total weight of the polyamide composition.

The polypropylene can be a homopolypropylene or a copolymer of propylene with other comonomers. Preferably, the polypropylene in this invention is a homopolypropylene with a melt index of 5 to 70 g/10 min, preferably a homopolypropylene with a melt index of 8 to 40 g/10 min, and the melt index is a polypropylene resin measured according to ISO 1133-1-2011 at 230° C. and a load of 2.16 kg.

### (c) Compatibilizer

To facilitate the preparation of the article, a compatibilizer is further added to the polyamide composition. The term “compatibilizer” in the connection of the invention generally refers to a compound capable of making the mix of other immiscible polymers better.

The compatibilizer is one or more selected from maleic anhydride grafted polypropylene, maleic anhydride grafted copolymer of propylene and ethylene, polypropylene-maleic anhydride copolymers, glycidyl methacrylate grafted polypropylene, polyethylene-glycidyl methacrylate copolymers. Preferably, the compatibilizer is selected from maleic anhydride grafted polypropylene and maleic anhydride grafted copolymer of propylene and ethylene. Most preferably, the compatibilizer is maleic anhydride grafted polypropylene.

The amount of the compatibilizer in the polyamide composition is 0.5 wt % to 10 wt %, preferably 1 wt % to 8 wt %, more preferably 3 wt % to 5 wt %, based on the total weight of the polyamide composition.

The amount of maleic anhydride and glycidyl methacrylate in the compatibilizer is preferably 0.02 wt % to 2.5 wt %, more preferably is 0.8 wt % to 1.8 wt %, based on the total weight of compatibilizer.

### (d) Reinforcing Fillers

The reinforcing fillers in the present invention can be for example, fibrous reinforcing fillers and are preferably selected from glass fibers, ceramic fibers, carbon fibers, and thermostable polymer fibers. More preferably, said reinforcing fillers are glass fiber.

The amount of the reinforcing fillers in the polyamide composition is 25 wt % to 50 wt %, preferably 30 wt % to 40 wt % and more preferably 30 wt % to 35 wt %, based on the total weight of the polyamide composition.

There is no specific limit to the glass fiber used in the invention, and any glass fiber known to the person skilled in the art are suitable in the present invention. The glass fiber can be produced by processes known to the person skilled in the art and can, if appropriate, be surface-treated or surface-modified, particularly with a coupling agent or coupling-agent system, preferably with a coupling-agent system based on silane. However, the pre-treatment is not essential. It is also possible to use polymer dispersions, film formers, branching agents and/or glass fiber processing aids, in addition to silane.

In one preferred embodiment, glass fiber with diameter from 5 to 20 μm, preferably from 7 to 13 μm, particularly preferably from 9 to 11 μm is used.

The glass fiber incorporated can take either the form of chopped glass fiber or else that of continuous-filament strands (rovings). The length of the glass fiber which can be used is generally and typically from 1 to 5 mm, prior to incorporation in the form of chopped glass fiber into the polyamide composition. The average length of the glass fiber after their processing, for example via coextrusion, with the other components, is usually from 100 to 600 μm, preferably from 150 to 400 μm.

There is no limitation of the type of glass fiber, A-glass fiber, E-glass fiber, D-glass fiber, C-glass fiber, R-glass fiber, E-CR-glass fiber, S-glass fiber can be used in the present invention.

### Other Components

The polyamide composition of the present invention could also comprise various additives so long as the additives do not adversely affect the desired properties of the polyamide composition in the invention.

In one preferred embodiment, the polyamide composition according to the invention can comprise at least one other conventional additive in addition to the components PA 6, PP, a compatibilizer, reinforcing fillers, where the total of all of the percentages by weight is always 100.

Preferred additives for the purposes of the present invention include stabilizers, flow aids, nucleating agents, lubricants, dyes, pigments, dehumidifier and so on. The additives mentioned and other suitable additives are described by way of example in Gächter, Müller, Kunststoff-Additive [Plastics Additives], 3rd edition, Hanser-Verlag, Munich, Vienna, 1989 and in Plastics Additives Handbook, 5th edition, Hanser-Verlag, Munich, 2001. The additives can be used alone or in a mixture or in the form of masterbatches, preferably in the form of masterbatches.

Preferred stabilizers are heat stabilizers and UV stabilizers. Stabilizers preferably used are copper(I) halides, preferably chlorides, bromides or iodides in conjunction with halides of alkali metals, preferably sodium halides, potassium halides and/or lithium halides, and other preferred stabilizers used are sterically hindered phenols, hydroquinones, phosphites, aromatic secondary amines such as diphenylamines, substituted resorcinols, salicylates, benzotriazoles or benzophenones, and also variously substituted representatives of the said groups or a mixture of these. Typical stabilizer includes for example sodium hypophosphite, diphenylamine.

Preferred nucleating agents used are sodium phenylphosphinate or calcium phenylphosphinate, aluminium oxide, silicon dioxide and also preferably talc powder.

Preferred lubricants and mould-release agents used are ester waxes, pentaerythritol tetrastearate (PETS), long-chain fatty acids, particularly preferably stearic acid or behenic acid and esters, salts of these, particularly preferably Ca stearate or Zn stearate, and also amide derivatives, preferably ethylenebisstearamide or montan waxes, preferably mixtures of straight-chain, saturated carboxylic acids having chain lengths of from 28 to 32 carbon atoms, and also low-molecular-weight polyethylene waxes or low-molecular-weight polypropylene waxes.

Preferred plasticizers used are dioctyl phthalate, dibenzyl phthalate, butyl benzyl phthalate, hydrocarbon oils and N-(n-butyl)benzenesulphonamide.

Preferred pigments or dyes used are titanium dioxide, ultramarine blue, iron oxide, carbon black, phthalocyanines, quinacridones, perylenes, nigrosine and anthraquinones.

Preferred dehumidifier is for example phenol with an amount of 0-5 wt % of the total polyamide composition.

In one preferred embodiment, the polyamide composition comprising
(a) 15 wt % to 30 wt % of PA 6,
(b) 36 wt % to 45 wt % of polypropylene,
(c) 0.02 wt % to 2.5 wt % of a compatibilizer,
(d) 25 wt % to 50 wt % of reinforcing fillers, and
(e) 0 wt % to 10 wt % of additives, based on the total weight of the polyamide composition.

In one preferred embodiment, the polyamide composition comprising
(a) 15 wt % to 30 wt % of PA 6,
(b) 36 wt % to 45 wt % of polypropylene,
(c) 0.02 wt % to 2.5 wt % of a compatibilizer,
(d) 25 wt % to 50 wt % of reinforcing fillers, and
(e) 1 to 8 wt % of additives including 0-5 wt % of dehumidifier and
0 to 5 wt % of stabilizer, colorants, nucleating agents and lubricant; based on the total weight of the polyamide composition.

In one preferred embodiment, the polyamide composition comprising
(a) 15 wt % to 30 wt % of PA 6,
(b) 36 wt % to 45 wt % of polypropylene,
(c) 0.02 wt % to 2.5 wt % of a compatibilizer, the compatibilizer is selected from maleic anhydride grafted polypropylene, maleic anhydride grafted copolymer of propylene and ethylene, polypropylene-maleic anhydride copolymers,
(d) 25 wt % to 50 wt % of reinforcing fillers, and
(e) 1-5 wt % of dehumidifier and 1 to 5 wt % of stabilizer, colorants, nucleating agents and lubricant; based on the total weight of the polyamide composition, based on the total weight of the polyamide composition.

In one preferred embodiment, the polyamide composition comprising
(a) 15 wt % to 30 wt % of PA 6,
(b) 36 wt % to 45 wt % of polypropylene,
(c) 0.02 wt % to 2.5 wt % of a compatibilizer, the compatibilizer is selected from maleic anhydride grafted polypropylene, maleic anhydride grafted copolymer of propylene and ethylene, polypropylene-maleic anhydride copolymers, the amount of maleic anhydride in the compatibilizer is 0.02 wt % to 2.5 wt %, preferably is 0.8 wt % to 1.8 wt %, based on the total weight of compatibilizer,
(d) 25 wt % to 50 wt % of reinforcing fillers, and
(e) 1-5 wt % of dehumidifier and 1 to 5 wt % of stabilizer, colorants, nucleating agents and lubricant; based on the total weight of the polyamide composition, based on the total weight of the polyamide composition.

The present invention also discloses a manufacturing method of the polyamide composition, comprising combining all components of the polyamide composition by injection molding, extruding or blowing molding. In a preferred embodiment, the manufacturing could be extruding or melt kneading. Preferred process of extruding is: all the components of the polyamide composition being fed into the main throat of a screw extruder, and extruding.

The present invention also discloses use of the polyamide composition in preparing an article contacting a cooling medium, especially in the cooling circuit of an automobile. The cooling circuit of an automobile, for example includes cooling-water-distribution systems, cooling-water tanks, cooling-water expansion containers, thermostat housings, cooling-water pipes, heat-exchanger housings and cooling-system connectors.

Still further, the present invention provides an article prepared from the above-mentioned polyamide composition. The article of the present invention is preferably an article in contact with a cooling medium, and is preferably used in cooling circuit of an automobile. Preferably, the articles are selected from cooling water pipers, cooling water flexible pipes, connecting elements thereof, cooling water manifolds, cooling water containers, cooling water compensation containers, thermostat housings and heat exchanger housings.

According to the present invention, the article prepared from the above polyamide composition has achieved improved hydrolytic resistance.

In the present invention, all the technical features mentioned above could be freely combined to form the preferred embodiments.

### EXAMPLES

The following non-limiting examples illustrate various features and characteristics of the present invention, the scope of the present invention should not to be construed as limited thereto.

The formulations for the examples and comparative examples are shown in the following Table 1 and the specific components used therein are:
PA 6: Ultramid® B27 E, purchased from BASF
PP: YUNGSOX® 1250D, purchased from Formosa Plastics
Glass fiber: ECS301HP10, purchased from CPIC

### Compatibilizer

MAH-POE: Fusabond N493, purchased from DOW
MAH-EP: Fusabond N353, purchased from DOW
MAH-PP: Fusabond N613, purchased from DOW
Phenol resin: Durez 28391, purchased from SUMITOMO BAKELITE EUROPE

The composition of said additives is listed as below:

| | |
|---|---|
| Stabilizer: NaH₂P Sodium hypophosphite | 0.05 wt % |
| Stabilizer: Naugard 445 | 0.7 wt % |
| Nucleating agent: talc 100 | 0.15 wt % |
| Lubricant: PETS | 0.2 wt % |
| Colorants | |
| Ultrabatch 420 special black 4 carbon black 30% + PA6 70% | 0.33 wt % |
| Ultrabatch 434 40% nigrosine + PA 6 60% | 0.25 wt % |

The extruding condition for the following examples was:

The raw materials were mixed together in a Dry blender, fed into a Twin-screw extruder; meltextruded under a temperature of 245° C., pelletized, thus obtaining a polyamide composition in a pellet form.

The dried pellets were processed in an injection molding machine LS-80, with a clamping force of 80 T at melt temperatures of 235° C. to 250° C. to give test specimens.

All the components of the polyamide compositions of examples E1-E6 and comparative examples C1-C6 are respectively listed in Table 1.

Flexural strength test was carried out according to DIN EN ISO 178 and values were giving in MPa.

Flexural strength after aging was determined after aging the specimen in a G48/water mixture (1:1 by weight) at 135° C. for 1000 hours. Following the aging process, flex strength was determined according to DIN EN ISO 178 at room temperature and values were given in MPa.

TABLE 1

| Formulation (wt %) | | E1 | E2 | E3 | E4 | E5 | E6 | C1 | C2 | C3 | C4 | C5 | C6 |
|---|---|---|---|---|---|---|---|---|---|---|---|---|---|
| PA6 | | 22.32 | 20.32 | 24.32 | 17.32 | 15.32 | 22.32 | 63.32 | 27.32 | 22.32 | 22.32 | 27.32 | 27.32 |
| PP | | 36 | 36 | 36 | 41 | 41 | 36 | — | 36 | 36 | 41 | 31 | 31 |
| Compatibilizer | MAH-POE | — | — | — | — | | | — | — | 5 | — | — | — |
| | MAH-EP | — | — | — | — | | 5 | — | — | — | — | 5 | — |
| | MAH-PP | 5 | 5 | 3 | 5 | 5 | | — | — | — | — | — | 5 |

| | | | | | | | | | | | | |
|---|---|---|---|---|---|---|---|---|---|---|---|---|
| Glass fiber | 35 | 35 | 35 | 35 | 35 | 35 | 35 | 35 | 35 | 35 | 35 | 35 |
| Phenol resin | — | 2 | — | — | 2 | — | — | — | — | — | — | — |
| Additive | 1.68 | 1.68 | 1.68 | 1.68 | 1.68 | 1.68 | 1.68 | 1.68 | 1.68 | 1.68 | 1.68 | 1.68 |
| Sum | 100 | 100 | 100 | 100 | 100 | 100 | 100 | 100 | 100 | 100 | 100 | 100 |

Properties

| | | | | | | | | | | | | |
|---|---|---|---|---|---|---|---|---|---|---|---|---|
| Flex strength before aging | 168 | 171 | 161 | 162 | 164 | 159 | 288 | 117 | 114 | 105 | 168 | 168 |
| (MPa) | | | | | | | | | | | | |
| Flex strength after aging | 83.7 | 85.9 | 80.9 | 83.7 | 87.5 | 68.1 | 35.9 | 50.7 | 63.7 | 57.2 | 53 | 57 |
| at 135° C./1000 hr (coolant: | | | | | | | | | | | | |
| G48/H2O = 50/50) (MPa) | | | | | | | | | | | | |
| Surface check after aging | No | No | No | No | No | No | Small | Big | Big | Big | No | No |
| at 135° C./1000 hr (coolant: | crack or | crack or | crack or | crack or | crack or | crack or | crack | bubbles | bubbles | bubbles | crack or | crack or |
| G48/H2O = 50/50) | bubbles | bubbles | bubbles | bubbles | bubbles | bubbles | | | | | bubbles | bubbles |

From the results of E1-E6, the polyamide compositions comprising PA6, PP and compatibilizer each in the ranges recited in the present description, provide satisfying flex strength both before aging and after aging and their surface check after aging is superior without crack or bubbles.

On the contrary, the polyamide composition in C1 comprising only PA 6, glass fiber and a small amount of additive, which does not contain any PP and compatibilizer, is clearly not sufficient for achieving flex strength after aging (only 35.9 MPa) and meanwhile its surface check result shows small crack.

The composition in C2 additionally comprising 36 wt % of PP, with no compatibilizer, shows a much worsen flex strength before aging. The surface check with big bubbles in C2 additionally makes it not suitable for practical use in cooling circuit of an automobile. The composition in C4 having 41 wt % of PP, is similar with that of C2, whose properties tested are likewise not satisfactory.

By adding 5 wt % of MAH-POE as compatibilizer into the composition of C2, C3 improves the flex strength after aging compared with C2, but the flex strength before aging of C3 is not improved at all and the surface check shows big bubbles, which makes it not suitable for practical use in cooling circuit of an automobile either.

From the above examples and comparative examples, it has been demonstrated that the combination of PP and specific compatibilizer with PA 6 as disclosed in the present invention contributes to obtain a polyamide composition with improved hydrolytic resistance, which is suitable to prepare an article used in the cooling circuit of an automobile.

1. A polyamide composition comprising:
(a) 10 wt % to 40 wt % of polyamide 6,
(b) more than 35 wt % to 50 wt % of polypropylene,
(c) 0.5 wt % to 10 wt % of a compatibilizer, and
(d) 25 wt % to 50 wt % of reinforcing fillers,
wherein the amount of each component (a)-(d) is based on the total weight of the polyamide composition.

2. The polyamide composition according to claim 1, wherein the polyamide 6 is in the amount of 15 wt % to 35 wt %, based on the total weight of the polyamide composition.

3. The polyamide composition according to claim 1, wherein the viscosity number of the polyamide 6 is from 95 to 230 ml/g, determined according to ISO 307-2007.

4. The polyamide composition according to claim 1, wherein the polypropylene is in the amount of 36 wt % to 45 wt % based on the total weight of the polyamide composition.

5. The polyamide composition according to claim 1, wherein the polypropylene is a homopolypropylene with a melt index of 5 to 70 g/10 min, measured according to ISO 1131-1-2011 at 230° C. and a load of 2.16 kg.

6. The polyamide composition according to claim 1, wherein the compatibilizer is one or more selected from the group consisting of maleic anhydride grafted polypropylene, maleic anhydride grafted copolymer of propylene and ethylene, polypropylene-maleic anhydride copolymers, glycidyl methacrylate grafted polypropylene, and polyethylene-glycidyl methacrylate copolymers.

7. The polyamide composition according to claim 1, wherein the amount of the compatibilizer is 1 wt to 8 wt % based on the total weight of the polyamide composition.

8. The polyamide composition according to claim 1, wherein the reinforcing fillers are 30 wt to 40 wt % based on the total weight of the polyamide composition.

9. The polyamide composition according to claim 1, wherein the reinforcing fillers are glass fiber with diameter from 5 to 20 μm.

10. The polyamide composition according to claim 1, wherein the reinforcing fillers are glass fiber surface-modified with a coupling agent.

11. The polyamide composition according to claim 1, wherein the polyamide composition further comprises additives selected from the group consisting of stabilizers, flow aids, nucleating agents, lubricants, dyes, pigments, and dehumidifiers.

12. The polyamide composition according to claim 1, wherein the polyamide composition further comprises (e) 0-5 wt % of phenol resin.

13. A method of using the polyamide composition according to claim 1, the method comprising using the polyamide composition to prepare an article in a cooling circuit of an automobile, wherein the article is selected from the group consisting of cooling water pipers, cooling water flexible pipes, connecting elements thereof, cooling water manifolds, cooling water containers, cooling water compensation containers, thermostat housings, and heat exchanger housings.

14. A manufacturing process of the polyamide composition according to claim 1, the process comprising combining all components of the polyamide composition.

15. A method of using the polyamide composition according to claim 1, the method comprising using the polyamide composition to prepare an article for cooling circuits in automobiles.

16. An article prepared from the polyamide composition according to claim 1.

17. The article according to claim 16, wherein the article is selected from the group consisting of cooling water pipers, cooling water flexible pipes, connecting elements thereof, cooling water manifolds, cooling water containers, cooling water compensation containers, thermostat housings, and heat exchanger housings.

18. The polyamide composition according to claim 1, wherein the polyamide 6 is in the amount of 20 wt % to 30 wt % based on the total weight of the polyamide composition.

19. The polyamide composition according to claim 1, wherein the viscosity number of the polyamide 6 is from 110 to 170 ml/g, determined according to ISO 307-2007.

20. The polyamide composition according to claim 1, wherein the polypropylene is in the amount of 36 wt % to 41 wt % based on the total weight of the polyamide composition.
